(19) United States
(12) Patent Application Publication
(10) Pub. No.: US 2010/0302392 A1
(43) Pub. Date: Dec. 2, 2010

(54) PRESENTATION DEVICE

(76) Inventors: Masaki Tanabe, Nagoya (JP); Shinya Futamura, Toyota (JP); Masataka Furuya, Nagoya (JP)

Correspondence Address: OSTROLENK FABER GERB & SOFFEN, 1180 AVENUE OF THE AMERICAS, NEW YORK, NY, 100368403, US

(21) Appl. No.: 12/786,990

(22) Filed: May 25, 2010

(30) Foreign Application Priority Data
May 26, 2009 (JP) 2009-126294

(51) Int. Cl. H04N 5/14; H04N 5/232

(52) U.S. Cl. 348/211.99; 348/576; 348/E05.062

(57) ABSTRACT

A document presentation device 10 includes a video signal controller 50 adapted to output a video signal of a video image for display on a display unit 40; and a remote controller RC. The video signal controller 50 includes a video signal processing unit 60 for creating a live video image within the field captured by an image sensor 31a; a masking setting unit for setting the brightness differential of the masking region; and a masking image display control unit that upon receiving an instruction from a masking instruction unit of the remote controller RC, sets a portion of the live video image to a masking region based on settings that are set in advance through the masking settings portion, and displays the live video image on the display unit 40; and that upon receiving an instruction from a position instruction unit of the remote controller RC changes the position of the masking region.

This application claims the benefit of and priority from Japanese Application No. 2009-126294 filed May 26, 2009, the content of which is incorporated herein by reference.

### BACKGROUND OF THE INVENTION

1. Field of the Invention

The present invention relates to a presentation device adapted to capture and generate an image from a document etc, with a camera, and to display the image on an external display device.

2. Description of the Related Art

Presentation devices like that disclosed in JP-A 2008-301069 are utilized in instances in which document images captured by a camera are to be displayed on a monitor or projector for the purpose of making a presentation to an audience. Functions required of such document presentation devices include the ability to display documents in various ways so that the document content can be presented simply and effectively to an audience; for example, functions of enlarging or highlighting selected portions of a document in the display may be required.

With conventional document presentation devices however, the display means for enlarging or highlighting selected portions of a document typically requires performing an operation in proximity to the document presentation device, for example, an arrangement involving operation of buttons or other controls that are situated in proximity to the camera or the stage on which the document rests, or one requiring the user to mark portions of a document with a highlighting marker. This means that the user had to describe the document while standing at a location away from the monitor screen. A resultant problem is that effectiveness of presentation to the audience tends to suffer; and the need to operate buttons etc. is inconvenient as well.

### SUMMARY

An advantage of some aspects of the invention is to provide a presentation device whereby masking display during a presentation can be carried out through a simple operation, without the need for laborious operations.

According to an aspect of the invention is provided with a presentation device comprising: a video signal controller adapted to process a picture signal from an image sensor that captures a subject, and to output a video signal of a video image for display on a display unit; and a remote controller adapted to output a wireless signal to the video signal controller to instruct modification of the video image displayed on the display unit. The remote controller includes a masking instruction unit for instructing masking display of a portion of the video image; and a position instruction unit for instructing shifting of the display position of the masking display on the display unit. The video signal controller includes: a video signal processing unit for creating a live video image within field captured by the image sensor; a masking setting unit for setting in advance settings that include brightness of the masking region of the masking display and of other areas; and a masking image control unit that performs signal processing of a portion of the live video image with the brightness, to divide the entire region of the display unit in at least one of the horizontal direction and the vertical direction, and to create the masking region when receiving an instruction from the masking instruction unit; and that changes the display position of the masking region when receiving an instruction from the position instruction unit.

In the presentation device according to the first aspect, when the video signal controller performs signal processing of the picture signal from the image sensor and outputs a video signal, a video image is displayed on the display unit. In response to a wireless signal that reflects an instruction received from the remote controller, the video signal controller changes the video image that is displayed on the display unit. Specifically, the masking settings means of the video signal controller are used to preset a number of setting values which include masking size and the brightness differential between the masking region and other areas. While the video signal processing unit is producing the live video image within field captured by the image sensor and outputting a video feed to the display unit, if the video signal controller receives from the masking instruction unit of the remote controller RC a wireless signal instructing that a masking region be established, the masking image display controller establishes a masking region in a portion of the live video image, according to the masking region and brightness differential that are set previously by the masking setting portion. Also, if the masking image display controller receives an instruction from the position instruction unit of the remote controller, it changes the location of the masking region. Specifically, from a location away from the document and in proximity to the display unit, through one-touch operation of the remote controller the user may produce an accentuated display in which a portion of the live video image is differentiated from other areas by a brightness differential, and moreover may change the location of the masking region. Consequently, in the course of a presentation, masking display can be carried out through a simple operation, without the need for laborious operations such as setting the masking region.

In yet another aspect, the masking image display controller can be designed so that when a masking display command is received from the masking instruction unit, the entire screen of the display unit is reduced in brightness; and thereafter when an instruction is received from the position instruction unit, the masking region is moved in the horizontal direction or the vertical direction, thereby explicitly indicating that masking display is activated, and enhancing ease of operation.

While in the present invention the presentation device is embodied as a machine invention, it is not limited thereto, and could instead be embodied as a process invention for producing special image display modes through wireless signals from a remote controller.

### BRIEF DESCRIPTION OF THE DRAWINGS

FIG. 1 depicts a general configuration of a document presentation device according to an embodiment of the present invention;

FIG. 2 illustrates a remote controller;

FIG. 3 illustrates an electronic zoom display function;

FIG. 4 illustrates a still image capture display function;

FIG. 5 illustrates a highlighted display function;

FIG. 6 illustrates a masking display function;

FIG. 7 illustrates another mode of a masking display function;

FIG. 8 is a block diagram illustrating a video signal controller provided in a document presentation device;

FIG. 9 illustrates operation of an OSD that is set through a control panel and a mode setting unit;

FIG. 10 illustrates an interface for selecting OSD settings;

FIG. 11 is an illustration depicting field settings for a highlighted display;

FIG. 12 is an illustration depicting opacity settings for a highlighted display;

FIG. 13 illustrates a special image display mode in another embodiment;

FIG. 14 illustrates specialized image display in another embodiment; and

FIG. 15 illustrates a special image display mode in yet another embodiment.

### DESCRIPTION OF THE PREFERRED EMBODIMENTS

### (1) General Configuration of Document Presentation System 10

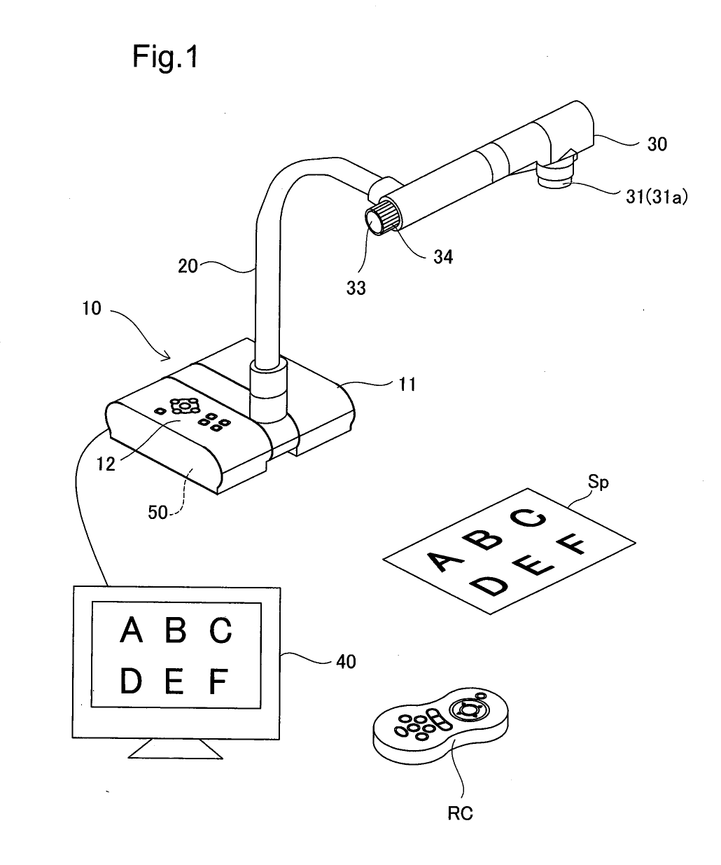

FIG. 1 is an illustration depicting a general configuration of a document presentation device according to an embodiment of the present invention. The document presentation device 10 is furnished with a control base 11 adapted to be placed on a desk or the like; a support arm 20 that curves upward from the control base 11; a camera head 30 that is secured to the upper end of the support arm 20; and a video signal controller 50 that is housed inside the unit. Also provided is a remote controller RC for controlling the video signal controller 50.

A control panel 12 is provided on the upper face of the control base 11. The control panel 12 includes a power switch; OSD (On-Screen Display) control buttons, discussed later; various buttons for switching between video outputs; a button for adjusting the brightness of the camera image, and so on. On the back panel of the control base 11 are provided various input/output terminals, not shown, such as a DC power terminal, analog RGB input/output terminals, and a USB terminal.

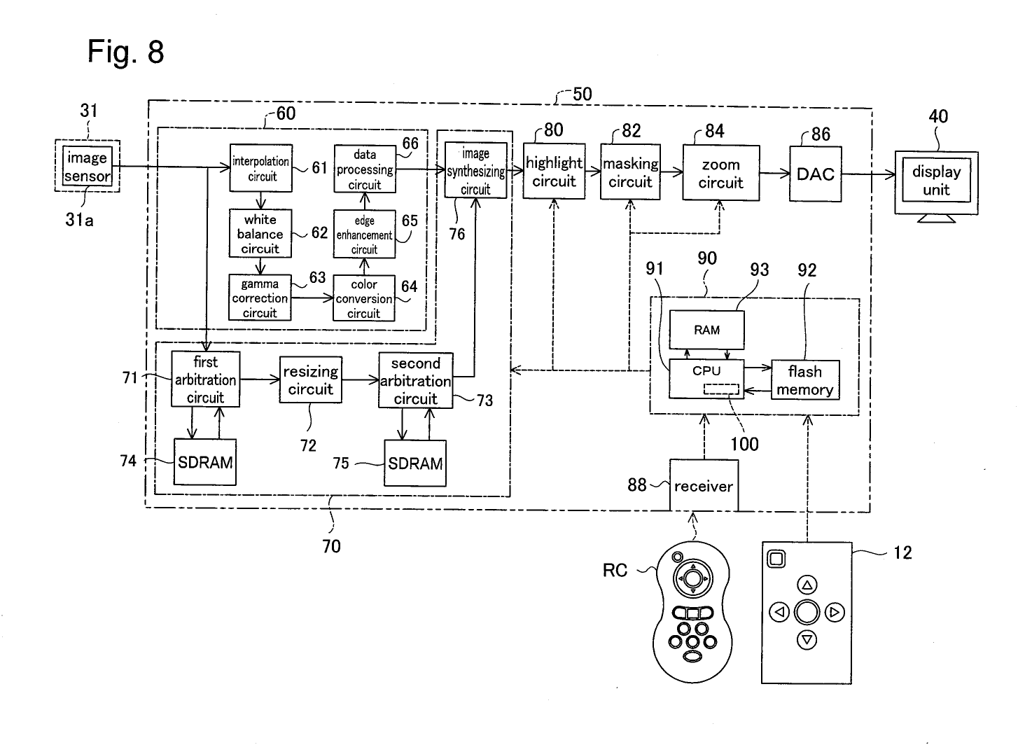

The camera head 30 is furnished with an imaging section 31 that has an image sensor 31a composed of a CCD (charge-coupled device), as well as a focal lens and zoom lens for focusing light; and an illumination lamp (not shown) that is positioned in proximity to the imaging section 31. Also provided are a focusing button 33 for focusing the lenses of the imaging section 31, and a zoom dial 34 for setting the optical zoom. The image sensor 31a converts light that is focused through the lenses into a picture signal, and outputs the picture signal to the video signal controller 50 (see FIG. 8) which is provided inside the control base 11. The video signal controller 50 performs image processing of various kinds then outputs a picture to a display unit 40 connected to the document presentation device 10. A CRT, liquid crystal display, projector, or television could be employed as the display unit 40 for example.

In the document presentation device 10, a document Sp is recorded by the imaging section 31 of the camera head 30, and this picture signal is processed by the video signal controller 50 so that the document is displayed on the display unit 40. The video signal controller 50 is also adapted to implement a number of special image display modes by receiving wireless signals from the remote controller RC. Here, digital zoom display, still image capture display, highlighted display, and masking display modes have been provided as special image display modes.

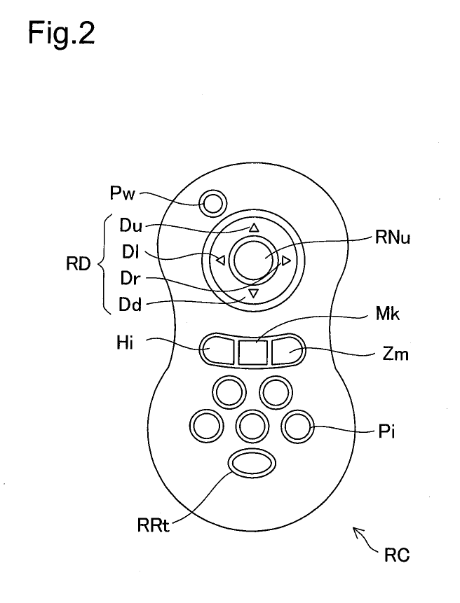

FIG. 2 is an illustration depicting the remote controller RC. The remote controller RC is provided with buttons of different types, i.e. a power button Pw; direction buttons RD (position instruction unit) including an up button Du, a down button Dd, a right button Dr, and a left button Dl arranged along the perimeter; and a confirm/menu button RNu situated at the center part between the direction buttons RD. As buttons for activating and terminating the special image display modes, there are provided a highlight button Hi (highlight instruction unit), a masking button Mk (masking instruction unit), and a zoom button Zm (zoom instruction unit) which have been arranged in the horizontal direction in the drawing; below these is arranged a still image capture button Pi (capture instruction unit) as well as a return button RRt and various buttons including ones for switching external memory and external computer inputs and outputs.

### (2) Overview of Special Image Display Modes

The description next turns to the special image display modes, which shall be described using as the document SP (see FIG. 1) a page having several characters of the alphabet imprinted thereon; this page is recorded, and a video image thereof is displayed on the display unit 40.

(2)-1 Digital Zoom Display Function

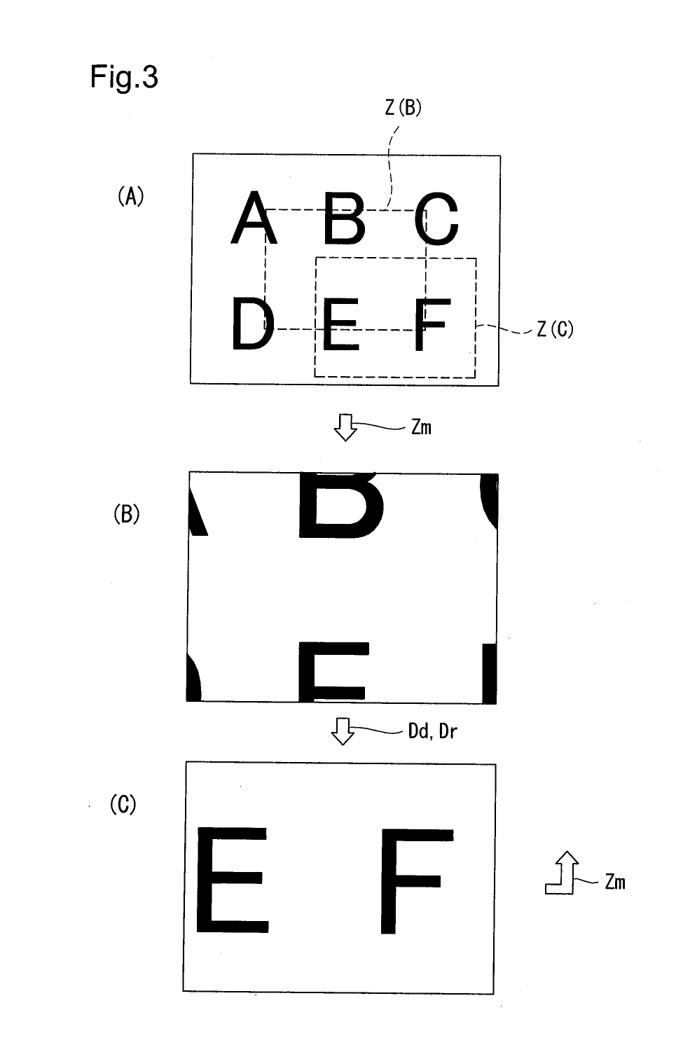

FIG. 3 is an illustration depicting the electronic zoom display function. With the document presentation device 10 displaying the normal live video image of FIG. 3 (A), if the zoom button Zm of the remote controller RC is pressed, a live video image having a magnified zoom region Z (B) in the center of the screen of the display unit 40 is displayed as shown in FIG. 3 (B). Specifically, the displayed live video image is one in which a portion of the document is magnified to an enlargement factor that is set beforehand by the user. By operating the shift controls of the remote controller RC, the zoom region Z can be shifted to any location on the screen. For example, by pressing the down button Dd and the right button Dr of the direction buttons RD shown in FIG. 2, the region could be changed to the zoom region Z (C) depicted in FIG. 3 (C). Pressing the zoom button Zm of the remote controller RC again cancels the digital zoom function and returns to the display of FIG. 3 (A).

(2)-2 Still Image Capture Display Function

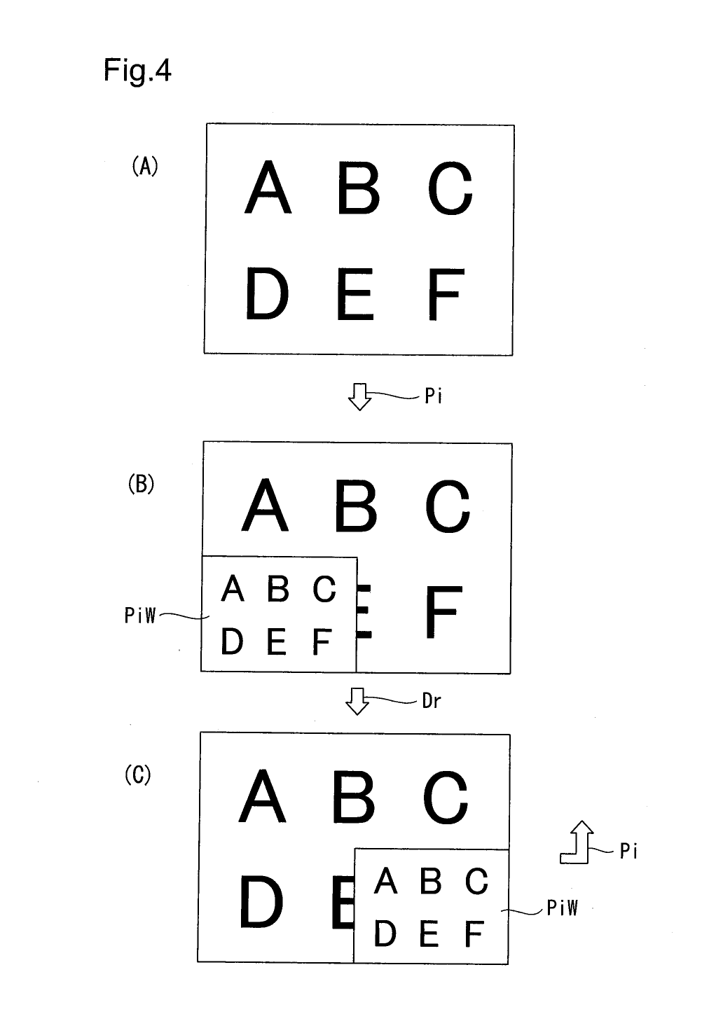

FIG. 4 is an illustration depicting the still image capture display function. With the document presentation device 10 displaying a normal live video image of FIG. 4 (A), if the still image capture button Pi of the remote controller RC is pressed, a still image equivalent to one frame of the picture signal from the imaging section 31 is temporarily saved in memory, and a capture window PiW resized to ¼ size is created and shown superimposed over the live video image, at the lower left of the screen of the display unit 40. By operating the shift controls of the remote controller RC, the capture window PiW can be shifted to the upper left, upper right, or lower left on the screen of the display unit 40. For example, by pressing the right button Dr of the direction buttons RD shown in FIG. 2, the window can be shifted to the lower right of the screen as depicted in FIG. 4 (C). Pressing the still image capture button Pi of the remote controller RC again cancels the still image capture display function and returns to the display of FIG. 4 (A).

(2)-3 Highlighted Display Function

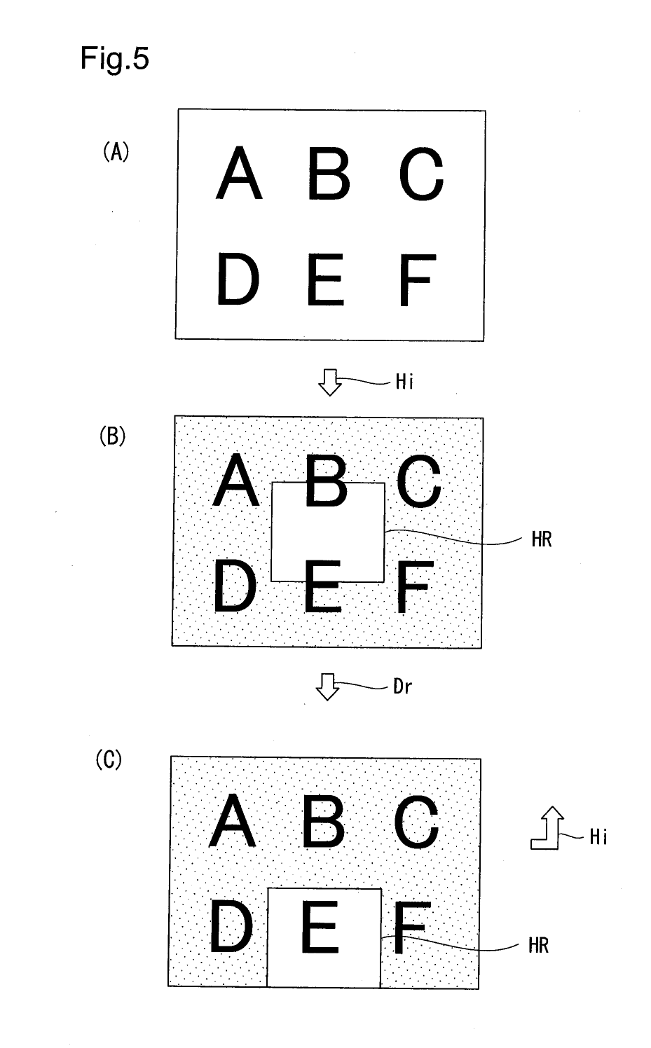

FIG. 5 is an illustration depicting the highlighted display function. With the document presentation device 10 displaying a normal live video image of FIG. 5 (A), if the highlight button Hi of the remote controller RC is pressed, a highlighted region HR is displayed on the screen of the display unit 40. The highlighted region HR is established using settings for size and opacity through different brightness from other areas, which settings have been made in advance by the user. By operating the shift controls of the remote controller RC, this highlighted region HR can be shifted to any location in the screen. For example, by pressing the down button Dd of the direction buttons RD shown in FIG. 2, the region can be shifted to the bottom center of the screen as depicted in FIG. 5 (C). Pressing the highlight button Hi of the remote controller RC again cancels the highlighted display function and returns the system to the display of FIG. 5 (C).

(2)-4 Masking Means

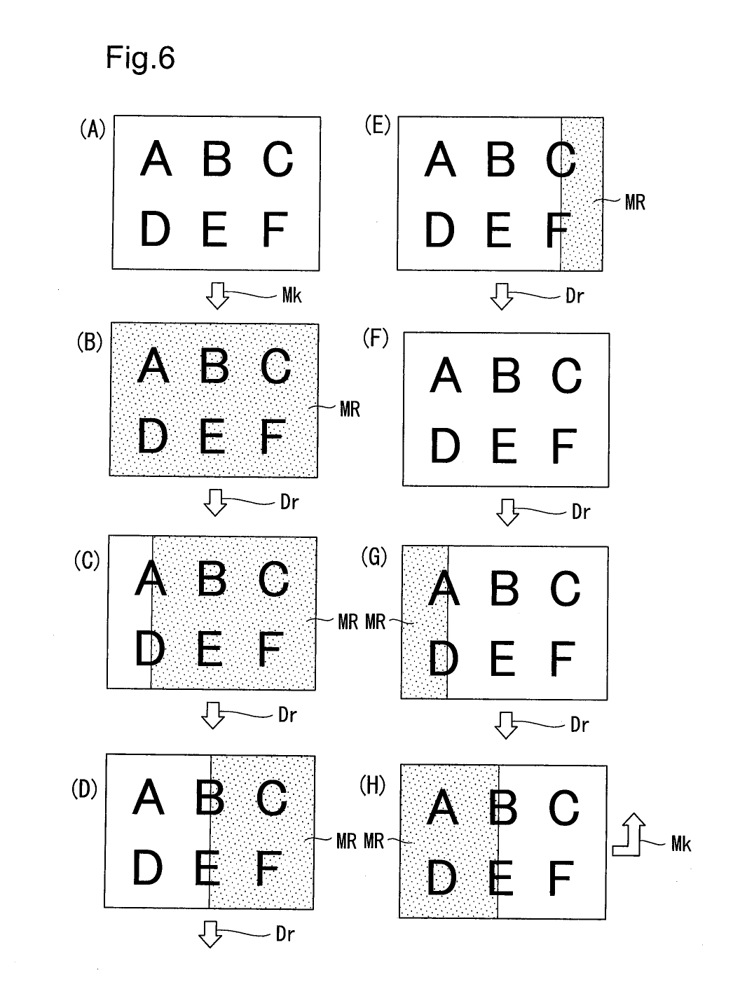

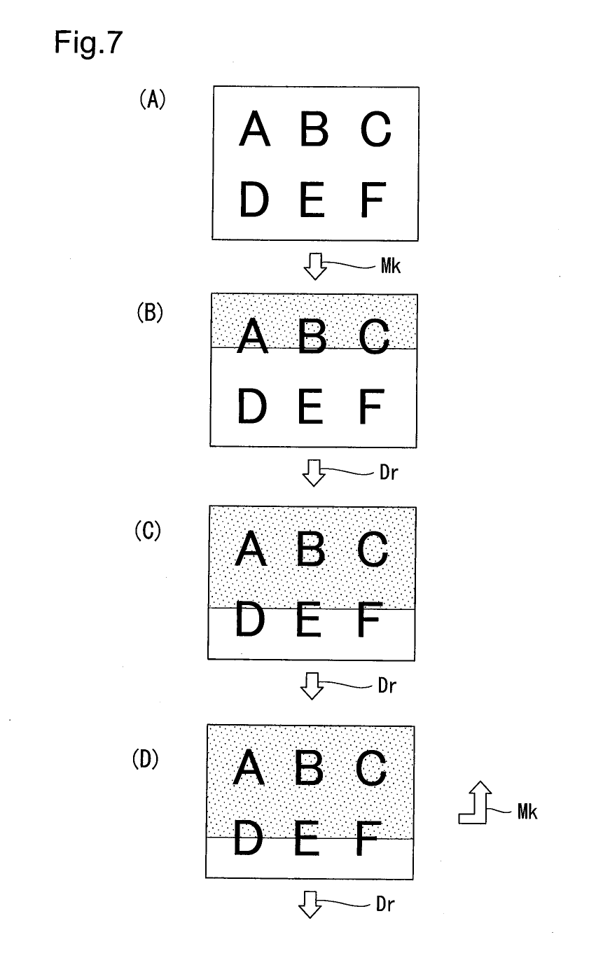

FIG. 6 is an illustration depicting a masking display function. During display of a normal live video image as depicted in FIG. 6 (A), if the masking button Mk of the remote controller RC is pressed, the document presentation device 10 displays the entire screen of the display unit 40 as a masking region MR. This masking region MR is displayed with an opacity level, i.e. reduced brightness of the masking region MR relative to other areas, that is set beforehand by the user. By operating the shift controls of the remote controller RC, the masking region MR can be resized in the horizontal direction of the screen. Specifically, each time that the right button Dr of the direction buttons RD of the remote controller RC is pressed once, the masking region MR is resized to prescribed width in the horizontal direction as shown in FIG. 6 (C) to FIG. 6 (H). Also, by pressing the left button Dl of the direction buttons RD, the masking region MR can be restored from the display FIG. 6 (D) to FIG. 6(C). Pressing the masking button Mk of the remote controller RC again cancels the masking display function and returns to the display of FIG. 6 (A). Through user settings, the masking region MR can also be switched to a mode of resizing in the horizontal direction, as shown in FIG. 7.

### (3) Configuration of Video Signal Controller 50 of Document Presentation System 10

FIG. 8 is a block diagram illustrating the video signal controller 50 provided in the document presentation device 10. The video signal controller 50 is a circuit that, in response to a picture signal input from the image sensor 31a of the imaging section 31 of the camera head 30, carries out various processes such as interpolation, white balance adjustment, and gamma correction in order to output a video signal of a video image for display on the display unit 40. The video signal controller 50 is furnished with a video signal processing unit 60, a capture circuit 70 (capture controller), a highlight circuit 80, a masking circuit 82, a zoom circuit 84 (zoom image controller), a video DAC 86, a receiver 88 for receiving wireless signals from the remote controller RC, and a microcomputer 90 for controlling these circuits.

The video signal processing unit 60 is furnished with an interpolation circuit 61 for generating missing color component values for pixels in the video signal from color components of surrounding pixels; a white balance circuit 62 for performing correction so that the white portions of the document are reproduced in white color; a gamma correction circuit 63 for adjusting the gamma characteristics of the video signal to produce sharp contrast; a color conversion circuit 64 for correcting hue; an edge enhancement circuit 65 for enhancing boundaries; and a data processing circuit 66. Here, the data processing circuit 66 is a circuit that converts RGB image data represented by the three primary color components R (red), G (green), and B (blue) (i.e. the RGB color space) to YCbCr image data represented by Y (luma) and Cb, Cr (chroma) (i.e. the YCbCr color space) and handles luma and chroma independently, so that the image data can be compressed with relatively minimal degradation in picture quality. Owing to the design of this video signal processing unit 60, the picture signal from the image sensor 31a undergoes various processing to create a live video image that extends through the entire imaging field.

The capture circuit 70 is a circuit for reproducing the still image capture display illustrated in FIG. 4, and is furnished with a first arbitration circuit 71; a resizing circuit 72; a second arbitration circuit 73; memory 74, 75 such as SDRAM operating in sync with a clock signal of a given cycle; and an image synthesizing circuit 76. The first arbitration circuit 71 is a circuit that, in response to an instruction from the microcomputer 90, fetches still image data equivalent to a single frame from the picture signal of the image sensor 31a. The still image data is then temporarily saved to the memory 74, and then at prescribed timing is reduced to one—fourth size by the resizing circuit 72 and sent to the second arbitration circuit 73. The second arbitration circuit 73 temporarily holds the reduced still image data in the memory 75, and in response to an instruction from the microcomputer 90 sends the data to the image synthesizing circuit 76. The image synthesizing circuit 76 then superimposes onto the live video signal output from the video signal processing unit 60 the still image that is resized to one—fourth screen size, and sends this signal to the highlight circuit 80 of the next stage. Here, the image synthesizing circuit 76 is designed so that the display location of the capture window PiW can be changed via the microcomputer 90, through operation of the direction buttons of the remote controller RC.

The highlight circuit 80 is a circuit for producing a signal to establish a highlighted region HR in a portion of the live video image as illustrated in FIG. 5. This highlighted region HR is established with a size and opacity level that have been set in advance by the user, as will be discussed later. The highlighted region HR is designed to be moved to any location in the image via the microcomputer 90, through operation of the direction buttons RD of the remote controller RC.

The masking circuit 82 is a circuit for producing a signal to establish a masking region in a portion of the live video image as illustrated in FIGS. 6 and 7. This masking region MR is established with a direction and opacity level that have been set in advance by the user, as will be discussed later. The masking region can be moved to any location in the image via the microcomputer 90, through operation of the direction buttons RD of the remote controller RC.

The zoom circuit 84 is a circuit for producing a signal for the purpose of zoom display to enlarge a portion of the live video image as illustrated in FIG. 3. This zoom display takes place at the enlargement factor set in advance by the user. The zoom field can be moved to any location in the image via the microcomputer 90, through shift operation of the remote controller RC.

The video DAC 86 is a circuit adapted to convert the digital signal output by the zoom circuit 84 to an analog RGB signal to be sent to the display unit 40; and through this RGB signal sends a live video stream, as well as sending various special image display modes. The microcomputer 90 is furnished with a CPU 91; a flash memory 92 which is a type of nonvolatile memory; and RAM 93. The CPU 91 has an internal mode setting unit 100 for making OSD settings, discussed later. The flash memory 92 stores a program for controlling the circuits, special image display modes, and the OSD mentioned above. The CPU 91 executes this program while using the RAM as the work area. The microcomputer 90 also connects to the receiver 88 for the remote controller RC, receives signals from the remote controller RC, and outputs to the aforementioned components the settings that have been made in the mode setting unit 100 of the CPU 91 through operation of the control panel 12.

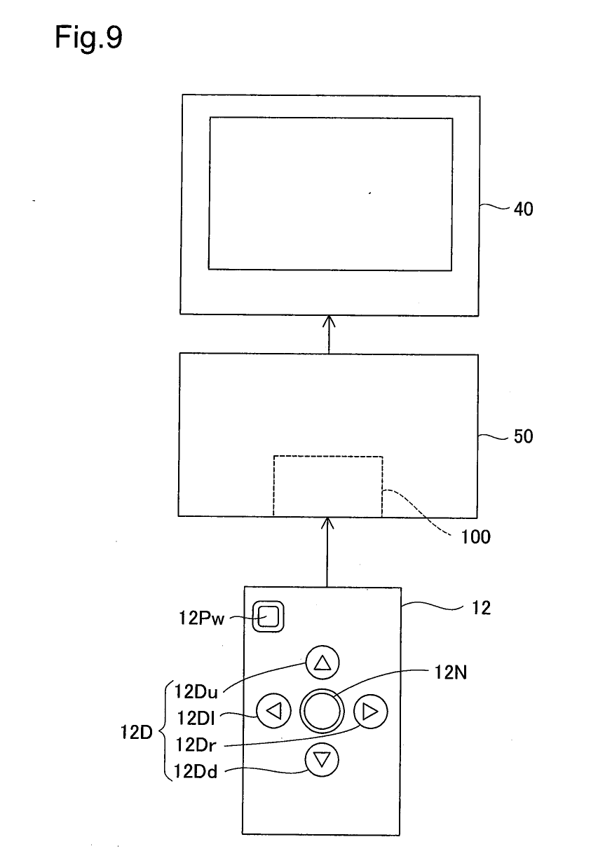

FIG. 9 is an illustration depicting operation of an OSD set through the control panel 12 and the mode setting unit 100. The OSD is the graphical user interface for making various settings and performing operations with respect to the document presentation device 10. On the control panel 12 are arranged various control buttons, specifically, a power button 12Pw; direction buttons RD including an up button 12Du, a down button 12Dd, a right button 12Dr, and a left button 12Dl arranged along the perimeter; and a confirm/menu button 12N situated at the center part between the direction buttons 12RD.

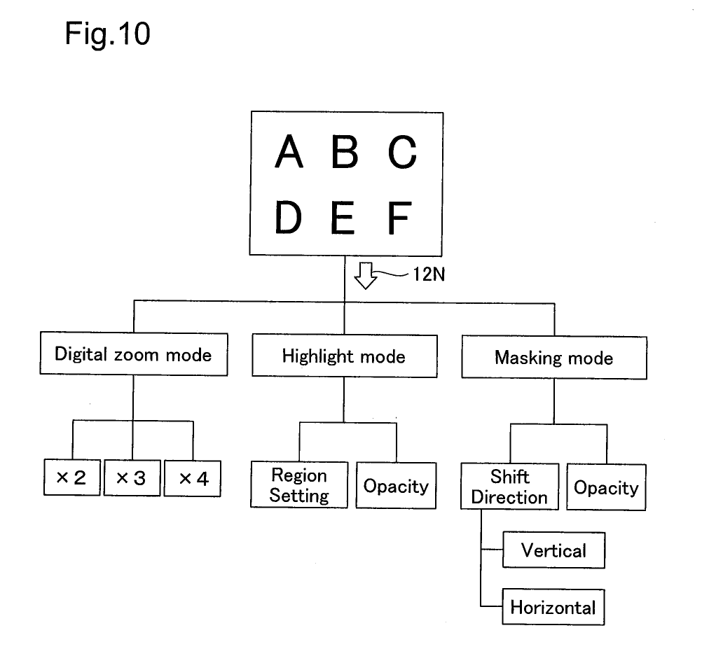

FIG. 10 is an illustration depicting the interface for selecting OSD settings. When the confirm/menu button 12N is pressed, special image display mode setting items appear on-screen in addition to the color tone and camera adjustments. Through appropriate selection of these items using the direction buttons 12D, the default settings for the special image display modes can be modified to other settings. Specifically, pressing the confirm/menu button 12N enables “Digital zoom mode”, “Highlight mode” and “Masking mode” items to be selected; after selecting one of these items with the direction buttons 12D, the selection is confirmed with the confirm/menu button 12N. Here, if digital zoom mode is selected, a screen for selecting the enlargement factor from among 2×, 3×, and 4× is displayed, and after making the desired selection through operation of the direction buttons 12D, the level is confirmed by pressing the confirm/menu button 12N. This enlargement factor setting is saved to RAM 93 by the CPU 91, and becomes effective when the zoom button Zm of the remote controller RC is pressed.

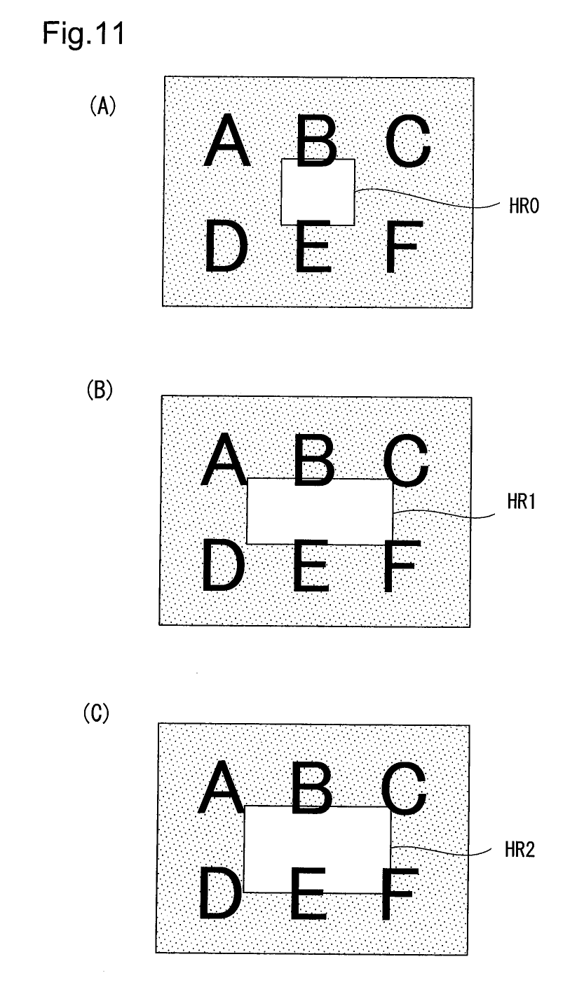

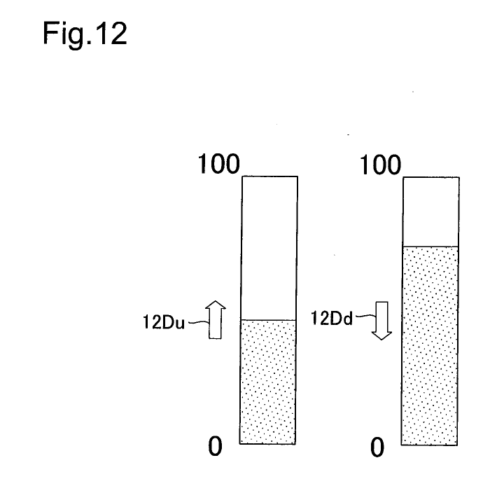

If “Highlight mode” is selected after pressing the confirm/menu button 12N, the items “Region Setting” and “Opacity” is displayed. If “Region Setting” is selected, a default highlighted region HR0 like that depicted in FIG. 11 (A) is displayed. The size can then be adjusted with the direction buttons 12D. For example, by pressing the right button 12Dr, size in the lateral direction can be increased as shown by the highlighted region HR1 of FIG. 11 (B); while by pressing the up button 12Du, size in the vertical direction can be increased as shown by the highlighted region HR2 of FIG. 11 (C). On the other hand, if “Opacity” is selected, a settings screen like that shown in FIG. 12 is displayed, and the value can be changed by operating the up button 12Du and the down button 12Dd. Here, opacity refers to the extent to which the brightness setting is lower in areas outside the highlighted region. That is, in areas outside the highlighted region, brightness is reduced to a lower level than in the highlighted region, and a numerical value is set for reduced brightness. For example, in the case where brightness values that can range from 0 to 255 are output for each individual pixel making up the image, set values could be subtracted from pixel has have the effect of making the highlighted region HR brighter relative to other areas.

If “Masking mode” is selected after pressing the confirm/menu button 12N, the items “Shift Direction” and “Opacity” is displayed. If “Shift Direction” is selected, “Vertical” and “Horizontal” is displayed; selecting “Vertical” switches to a mode in which the masking region MR shifts in the lateral direction as depicted in FIG. 6, while selecting “Horizontal” switches to a mode in which the masking region MR shifts in the vertical direction as depicted in FIG. 7. By selecting “Opacity” on the other hand, opacity of the masking region can be set in the same way as setting opacity of the highlighted region.

### (4) Effects of the Embodiment

The description now turns to the effects afforded by the features of the embodiment described above.

Through signal processing of the picture signal from the imaging section 31 by the video signal processing unit 60 of the video signal controller 50, a live video image can be displayed on the display unit 40 through the agency of the video DAC 86. This allows the user, from a location away from the document and in proximity to the display unit 40, to call up special image display modes in the following manner through one-touch button operation of the remote controller RC so that the presentation can be carried out in an a versatile and effective manner.

(4)-1 When the zoom button Zm of the remote controller RC is pressed, an enlarged image of part of the live video image is displayed at a predetermined enlargement ratio, and the enlarged field can be shifted through operation of the direction buttons RD. Additionally, by setting in advance the enlargement ratio for the zoom image, various requirements can be met through settings made by the user.

(4)-2 When the still image capture button Pi of the remote controller RC is pressed, the live image is reduced and displayed in the form of a still image on the screen; moreover, the still image can be shifted through operation of the direction buttons RD.

(4)-3 When the highlight button Hi of the remote controller RC is pressed, a highlighted region of preset different brightness from other areas is displayed; and the highlighted region can be shifted through operation of the direction buttons RD. Moreover, by setting in advance the brightness differential of the highlighted region relative to other areas, various requirements can be met through settings made by the user.

(4)-4 When the masking button Mk of the remote controller RC is pressed, a masking region MR of preset different brightness from other areas is displayed; and the masking region MR can be shifted through operation of the direction buttons RD. Moreover, by setting in advance the brightness differential of the masking region MR relative to other areas, various requirements can be met through settings made by the user.

### (5) Other Embodiments

The invention is not limited by the embodiment described above, and may be reduced to practice in various other modes without departing from the scope and spirit thereof. Possible modifications include the following, for example.

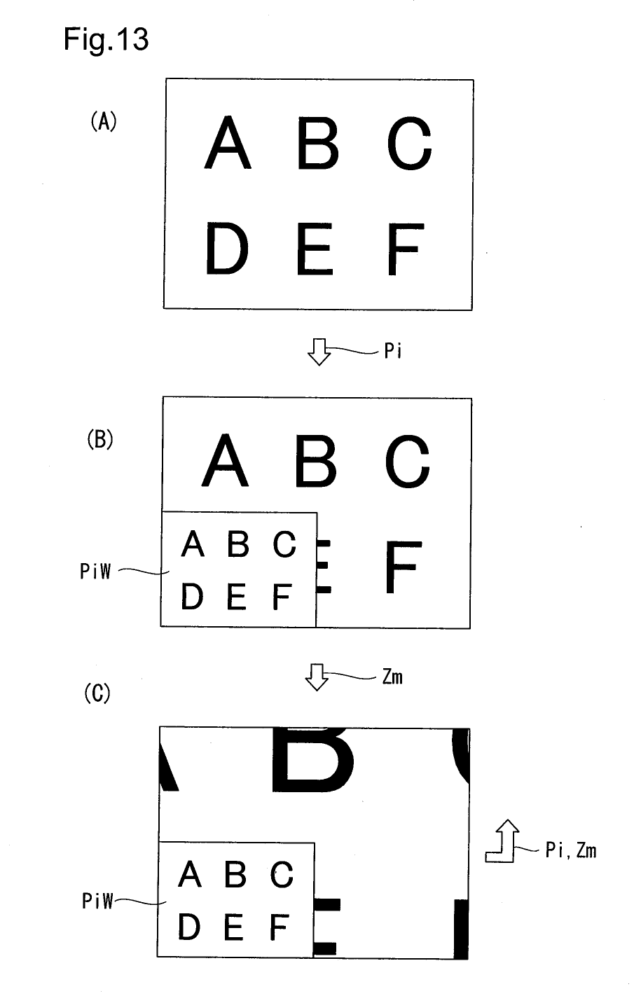

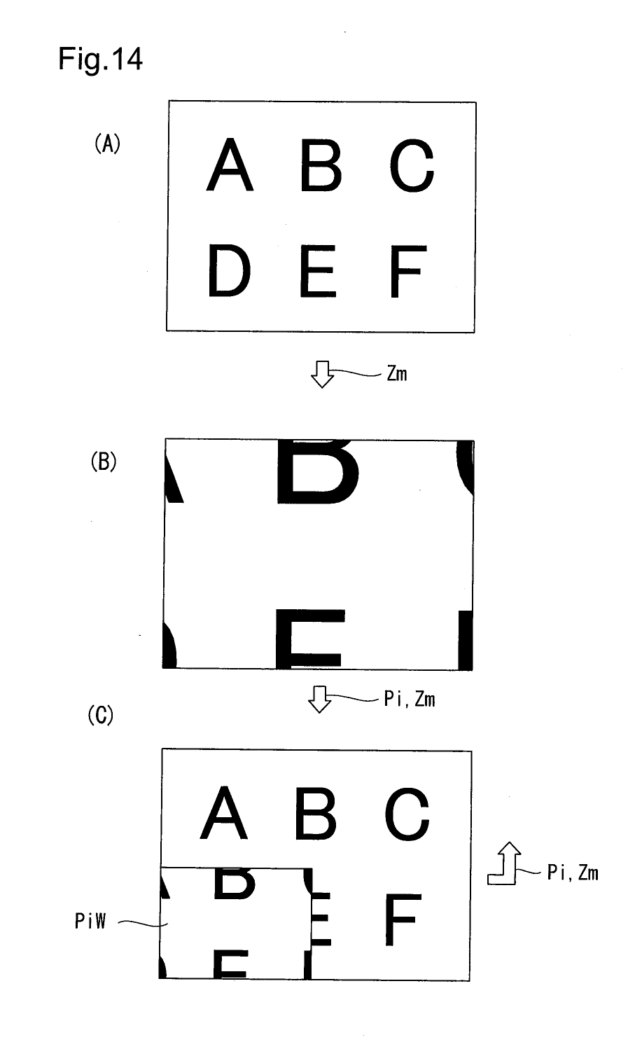

(5)-1 FIGS. 13 and 14 are illustrations depicting special image display modes according to another embodiment. The present embodiment features simultaneous still image capture display and digital zoom functions. Specifically, with the normal live video image of FIG. 13 (A) being displayed, if the still image capture button Pi of the remote controller RC is pressed, a capture window PiW is displayed at lower left on the screen as shown in FIG. 13 (B), and the entire live video image is displayed as a still image. In this state, if the zoom button Zm is pressed, a portion of the live video image of the document can be displayed in enlarged view, without increasing the size of the still image. This enables use in a process whereby a portion of the live video image of the document is displayed in enlarged view, while cross-referencing the entire document which is displayed as a still image. Alternatively, with the normal live video image being displayed as shown in FIG. 14 (A), if the zoom button Zm is pressed to bring up digital zoom display as shown in FIG. 14 (B), and then the still image capture button Pi is pressed again and the zoom button Zm is pressed again, the live video image can be displayed at normal size while at the same time displaying a zoomed still image as shown in FIG. 14 (C). This enables use in a process that makes it easier to ascertain relationships between the document as a whole and relevant portions thereof.

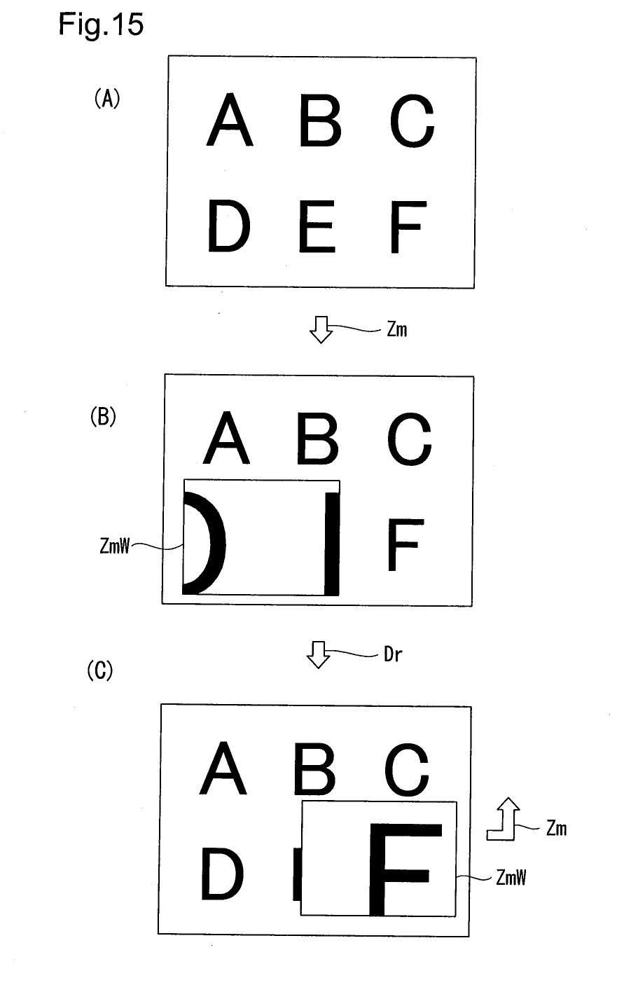

(5)-2 FIG. 15 is an illustration depicting a special image display mode according to yet another embodiment. The present embodiment features an arrangement for digital zoom display whereby an enlarged portion of the live video image may be displayed in a window. Specifically, with the normal live video image of FIG. 15 (A) being displayed, pressing the zoom button Zm brings up a zoom window ZmW that zooms a portion of the document (FIG. 15 (B)); this window may be shifted using the direction buttons RD of the remote controller RC (FIG. 15 (C)). This enables use in a process for enlarged display of detail portions of a document.

(5)-3 In the preceding embodiment, OSD settings are made through the control panel 12 of the control base 11, but this arrangement is not limiting, and OSD operations could instead be carried out through operation of the remote controller RC. In this case, with a battery providing a backup power source, user settings are retained even with the power off.

(5)-4 Various settings relating to special image display modes that are set by the user may be provided in addition to the OSD user setting items described above. For example, items for modifying parameters such as the shift distance of masking, the size of the captured still image, or color in order to create sharp distinction between the highlighted region or masking region from other areas in a highlighted display or masking display, could be set in advance.

(5)-5 In FIG. 8, the arrangement for producing special image display is achieved primarily through the capture circuit 70, the highlight circuit 80, the masking circuit 82, and the zoom circuit 84; however, the functions of these components may be selected appropriately.

(5)-6 Some of the functions implemented through software could instead be implemented through hardware, and vice-versa.

The foregoing detailed description of the invention has been provided for the purpose of explaining the principles of the invention and its practical application, thereby enabling others skilled in the art to understand the invention for various embodiments and with various modifications as are suited to the particular use contemplated. The foregoing detailed description is not intended to be exhaustive or to limit the invention to the precise embodiments disclosed. Modifications and equivalents will be apparent to practitioners skilled in this art and are encompassed within the spirit and scope of the appended claims.

What is claimed is:

1. A presentation device comprising: a video signal controller adapted to process a picture signal from an image sensor that captures a subject, and to output a video signal of a video image for display on a display unit; and a remote controller adapted to output a wireless signal to the video signal controller to instruct modification of the video image displayed on the display unit;
wherein the remote controller includes a masking instruction unit for instructing masking display of a portion of the video image; and a position instruction unit for instructing shifting of the display position of the masking display on the display unit; and
the video signal controller includes:
a video signal processing unit for creating a live video image within field captured by the image sensor;
a masking setting unit for setting in advance brightness of the masking region and other region of the display unit; and
a masking image control unit that performs signal processing of a portion of the live video image with the brightness, which divides the entire region of the display unit in at least one of the horizontal direction and the vertical direction, and creates the masking region when receiving an instruction from the masking instruction unit; and that changes the display position of the masking region when receiving an instruction from the position instruction unit.

2. The presentation device in accordance with claim 1 wherein
the marking instruction unit includes a masking button for instructing displaying of the masking image, and
the position instruction unit includes direction buttons for instructing shifting of the masking region on the display unit.

3. The presentation device in accordance with claim 1 wherein
the masking setting unit for setting in advance the size of the masking region and the brightness through selection from a plurality of values displayed on the display unit.

4. The presentation device in accordance with claim 3, further comprising a control base that includes (i) a camera head with the image sensor, (ii) the masking setting unit and (iii) the masking image control unit,
wherein the masking setting unit includes (i) a control panel with a bottom for setting the masking region and (ii) a mode setting unit for instructing the masking region to the masking control unit by operation of the bottom of the control panel.

5. The presentation device in accordance with claim 3, further comprising a control base that includes (i) a camera head with the image sensor, and (ii) the masking image control unit,
wherein the remote controller includes the masking setting unit that has a control panel with a bottom for setting masking region, the masking setting unit being configured to instruct the masking region to the masking image control unit by operation of the bottom of the control panel.

6. The presentation device in accordance with claim 1 wherein
the masking image control unit is configured to reduce the brightness of the entire screen of the display unit, then shift the masking region in the horizontal direction or the vertical direction when receiving a masking display instruction from the masking instruction unit.
